(19) United States
(12) Patent Application Publication
(10) Pub. No.: US 2010/0040397 A1
(43) Pub. Date: Feb. 18, 2010

(54) STRIPPER FINGER FOR USE IN A FUSER ASSEMBLY

(75) Inventors: Jerome GORRELL, Boston, NY (US); Timothy CARROLL, Logan Township, NJ (US)

Correspondence Address: SIMPSON & SIMPSON, PLLC, 5555 MAIN STREET, WILLIAMSVILLE, NY, 14221-5406, US

(73) Assignee: POLYMER CONVERSIONS, INC., Orchard Park, NY (US)

(21) Appl. No.: 12/541,259

(22) Filed: Aug. 14, 2009

Related U.S. Application Data
(63) Continuation of application No. 61/188,920, filed on Aug. 14, 2008.

(51) Int. Cl. G03G 15/20

(52) U.S. Cl. 399/323

(57) ABSTRACT

The present invention is a splitter finger for a fuser assembly such as is used in a photographic printing or copying machine. To provide the desired qualities of heat and wear resistance without using fabrication materials made using perfluorooctanoic acid (PFOA), the splitter fingers have bee fabricated from a variety of polymeric materials. In some embodiment, glass in the form of chopped glass and/or glass beads is added to at least the lifter portion of the splitter finger to provide additional stiffness.

### CROSS REFERENCE TO RELATED APPLICATIONS

This patent application claims the benefit under 35 U.S.C. §119(e) of U.S. Provisional Application No. 61/188,920, filed Aug. 14, 2008, which application is incorporated herein by reference in its entirety.

### FIELD OF THE INVENTION

The present invention relates generally to the field of photocopy machines, specifically to the discharge of paper after it receives an image, and more specifically to the components used to lift paper from a heated fuser roll after receiving an image.

### BACKGROUND OF THE INVENTION

The fluorinated compound PFOA (perfluorooctanoic acid) is commonly used as a processing agent in the manufacture of polytetrafluoroethylene or TEFLON® (PTFE) one of the most commonly used fluorinated polymer products. However, it has been determined that PFOA is an environmental hazard that is found at low levels throughout the general population and in high levels in populations near PTFE production facilities. For this reason, PTFE producers, such as DuPont, are conducting a phase out of the use of PFOA with the goal of eliminating its use by 2015. This phase out has caused some users of products fabricated from PTFE to explore substituting other materials for PTFE.

In the electrophotographic (photocopying) printing industry, stripper fingers are frequently fabricated from PTFE because of its resistance to heat and wear. In a typical electrophotographic copying or printing process, an electrostatic latent image is recorded on a photoconductive member. The electrostatic latent image is rendered visible by bringing one or more developer materials into contact therewith. Generally, the developer material comprises toner particles adhering triboelectrically to carrier granules. The toner particles are attracted from the carrier granules either to a donor roll or to a latent electrostatic image on the photoconductive member. When attracted to a donor roll, the toner particles are subsequently deposited on the latent electrostatic images. The toner powder image is then transferred from the photoconductive member to a final substrate or imaging media, such as paper. The toner particles forming the toner powder images are then subjected to a combination of heat and/or pressure to permanently affix the powder images to the copy substrate.

In order to use heat to fix permanently or fuse the toner material onto a substrate or support member such as plain paper, it is necessary to elevate the temperature of the toner material to a point at which constituents of the toner material coalesce and become tacky. This action causes the toner to flow to some extent onto the fibers and/or into the pores of the support member or otherwise upon the surface thereof. Thereafter, as the toner material cools, solidification of the toner material occurs causing the toner material to be bonded firmly to the support member.

One approach to thermal fusing of toner material images onto the final substrate or imaging media has been to pass the substrate with the unfused toner images thereon between a pair of opposed roller members, at least one of which is internally heated. During operation of a fusing system of this type, the substrate to which the toner images are electrostatically adhered is moved through a nip formed between the pressure engaged rolls with the toner images contacting the heated fuser roll to thereby effect heating of the toner images within the nip.

A plurality of stripper fingers is usually provided for separating the final substrate or imaging media from the heated fuser roll. The fingers physically contact the surface of the heated fuser roll such that the tips thereof are inserted between the lead edge of the paper or other imaging media and the heated fuser roll. Stationary baffles have been employed for receiving the imaging media once it has been separated from a heated fuser roll. Such baffles are supported in a fixed position downstream of the fuser nip for transporting or guiding imaged substrates toward the exit of a reproduction machine.

Because processing temperatures can reach 400° F. (˜200° C.), it is important that stripper fingers are fabricated from materials able to resist breakdown or deterioration over sustained exposure to such temperatures. In addition, stripper fingers are in continuous contact with the rotating fuser roller requiring that the stripper finger fabrication material be wear resistant as well as temperature resistant. Although PTFE meets these criteria, because of the need to remove PFOA from manufacturing processes, it is advantageous to fabricate stripper fingers from other wear-, temperature-resistant materials.

At least two other factors must be considered when fabricating fingers. First, fingers must be able to resist “creep” which is the slow deformation of an article that is subjected to constant stress, such as temperature or pressure, that is below a specific break point for example a melting point or puncture pressure. Second, fingers must possess a certain amount of stiffness in order to stay aligned on the fuser roller and within the carriage (not seen) holding the fingers. However, at the desired finger thicknesses of about 1.5 to 2.0 mm may not be sufficiently stiff to maintain alignment when the photocopier is operating.

Therefore, there is a problem in the field of fabricating stripper fingers that possess a degree of stiffness to enable them to stay in alignment and at the same time be able to withstand the temperatures generated from a heated fuser roller as well as to resist deformation from creep and general wear caused by constant contact with the rotating fuser roll.

### SUMMARY OF THE INVENTION

The present invention broadly comprises splitter finger for a fuser assembly comprising a body portion, with the body portion fabricated from a polymeric material and a lifter portion in which the lifter portion is fabricated from PFA, wherein one of either the body portion or the lifter portion includes an edge forming a notch and the other one of the body portion and the lifter portion includes an edge forming a protrusion shaped to fit into the notch to form an interference fit. In one embodiment, the lifter portion may include glass in the form of chopped glass and/or glass beads.

In an alternate embodiment, the present invention broadly comprises an integral stripper finger for a fuser assembly shaped to include a body portion and a lifter portion wherein said stripper finger is fabricated from a polymeric material. The polymeric material may be PFA, PEEK, PPS, or polyimide or similar materials. In one embodiment, the integral splitter finger includes glass in the form of chopped glass and/or glass beads.

One object of the invention is to provide a splitter finger for a fuser assembly used in a photographic machine the can withstand the operational temperatures of the fuser assembly.

A second object of the invention is to provide a splitter finger that withstands the wear created by resting on a rotating fuser roller.

A third object of the invention is to provide alternative splitter fingers that can be fabricated without PTFE.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 depicts a section of a typical fuser roller assembly showing a plurality of stripper fingers and an exit baffle;

FIG. 2 is a top perspective view of one embodiment of stripper finger;

FIG. 3 is a top perspective view of an alternate embodiment of the stripper finger in which the finger is formed from two joined body components; and,

FIG. 3A is top perspective view of the alternate embodiment in which the two body components are separated.

### DETAILED DESCRIPTION OF PREFERRED EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

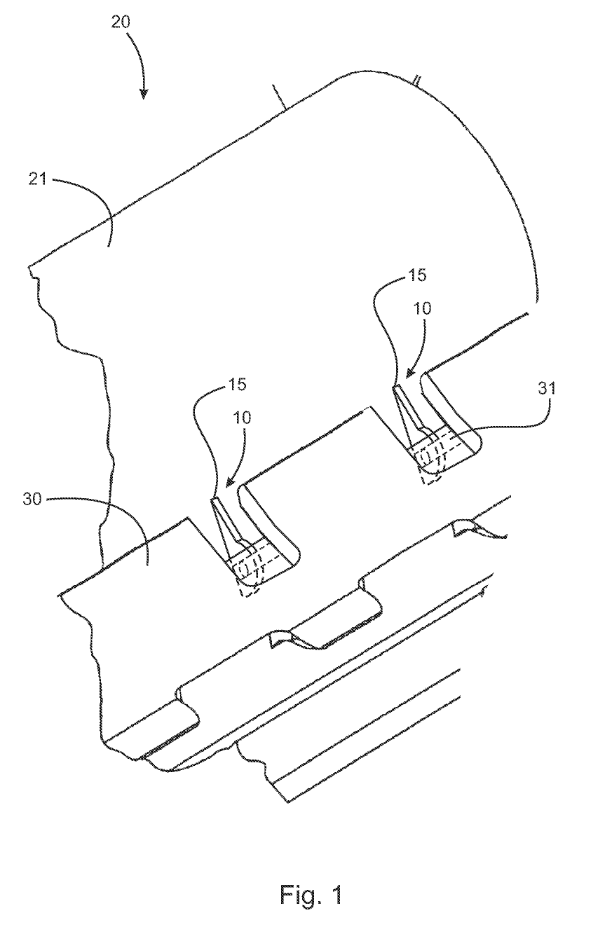

Adverting to the drawings, FIG. 1 depicts a section of a typical fuser roller assembly 20. Stripper fingers 10 (“finger(s) 10”) are seen contacting fuser roller 21 (“roller 21”). Baffle 30 controls the direction of printed paper or other media as it is removed from roller 21 by fingers 10. Fingers 10 may be advantageously formed to define an orifice through which a support rod 31 may extend to keep the plurality of fingers 10b aligned. Commonly, stripper fingers 10 rest on the smooth roller 21 that holds the image media (“paper”) after the paper receives the electrostatic toner that forms the image. As the roller rotates toward tip 15, tips 15 slip under the leading edge of the paper forcing the paper off the roller 21, while the rotation of the roller moves the paper to the next processing section of the printer. Commonly, the paper is directed to the next processing section by baffle 30.

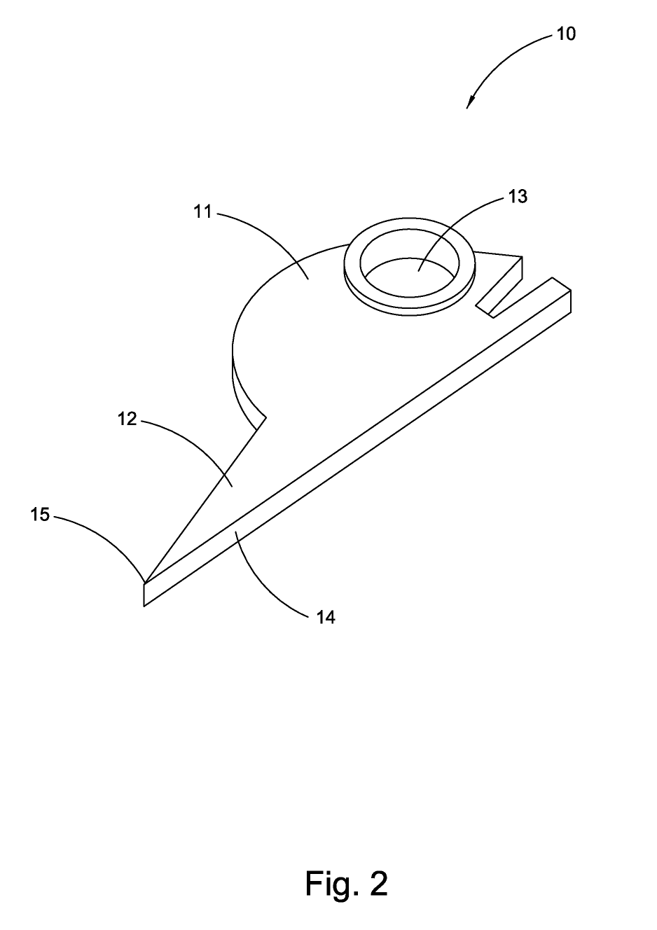

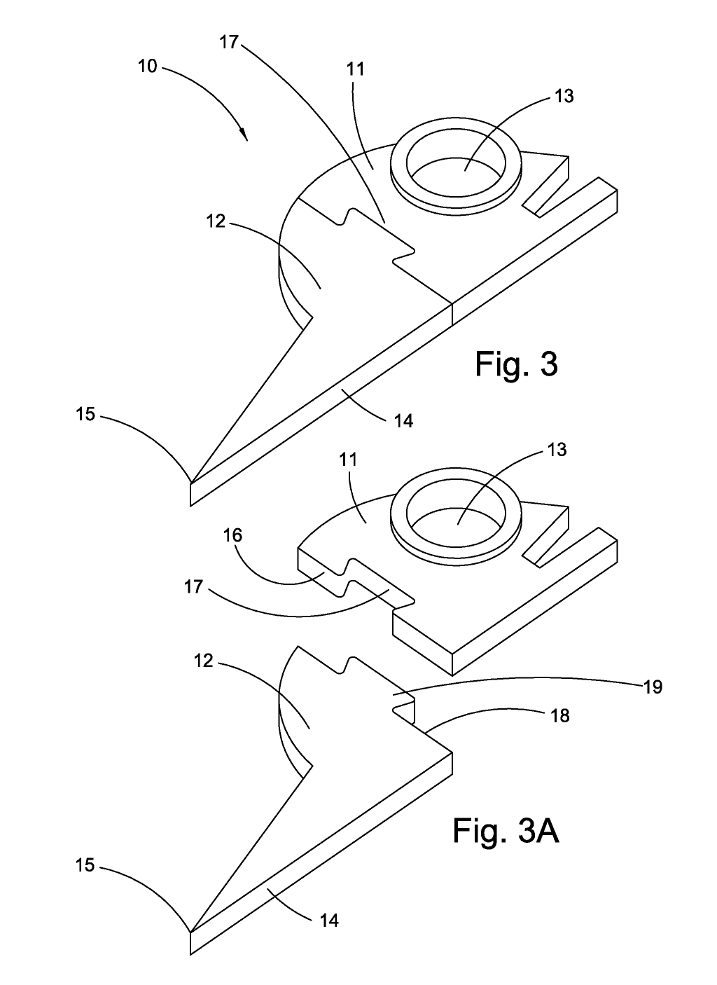

FIG. 2 is a top perspective view of one embodiment of stripper finger 10. As seen in FIG. 2, the stripper finger 10 includes a body portion 11 and a tip or lifter portion 12. The body portion usually defines a hole 13 through which a support rod passes that holds each of the plurality of fingers 10 in alignment. At least part of the bottom 14 of the lifter portion 12 rests on the fuser roller with the pointed tip 15 of the lifter portion pointing toward the paper

To combat the simultaneous problems of heat resistance and constant wear on fingers 10, PFA is a type of fluoropolymer that possesses excellent creep resistance as well as wear and temperature resistance. In addition, one alternate solution to the creep problem mentioned above is to make finger 10 thicker. By increasing the thickness of stripper finger 10 to range from approximately 1.5 to 4.5 mm, stiffness may be added simply by adding more polymer material to lifter portion 12 and/or body 11. Thickness may be increased in some or all of the body 11 and/or lifter portion 12 of finger 10. However, because lifter section 12 normally includes the least amount of material, it is preferred that the increased amount of material be added to lifter portion 12, if necessary.

Another solution to increase stiffness in stripper finger 10 is to add materials having a greater flexural modulus to the PFA fabrication material. Still another solution is to fabricate an integral splitter finger as seen in FIG. 2 fabricated from PFA or other polymeric materials. One such other polymeric material that may be used is polyetheretherketone (PEEK) which can be used in temperatures reaching 480° F. Other materials that may be used include polyphenylsulfide (PPS) and polyimides. These may be reinforced with chopped glass or glass beads which also act to increase stiffness in body portion 11 and lifter portion 12. Preferably the glass is E-glass (borosilicate) in which the chopped glass is approximately 10-12 microns in diameter and the glass beads range in diameter from about 25 to about a 35 microns in diameter. These blends can be made with processes well known to those having skill in the art. For example, stripper finger 10 may be fabricated using injection molding in which the various polymer resins and glass may be blended before or as they are added to the injection molding machine.

In an alternate embodiment, stripper finger 10 may be made up of separate body 11 and lifter 12 portions as seen in FIGS. 2 and 2A. These two portions may be shaped into complementary shapes with one portion having an edge 16 formed into a concave notch 17 and the joining edge on the other portion formed into a convex protuberance 19 shaped to snugly fit into the notch to form an interference fit seen in FIG. 2. An interference fit (sometimes called a press fit) is a fastening between two parts which is achieved by friction after the parts are pushed together, rather than by any other means of fastening. The interference fit may be augmented by an adhesive holding the two shaped edges together. In one embodiment, the adhesive may be covalently bonded to one or both of the edges.

Thus it is seen that the objects of the invention are efficiently obtained, although changes and modifications to the invention should be readily apparent to those having ordinary skill in the art, which changes would not depart from the spirit and scope of the invention as claimed.

We claim:

1. A stripper finger for a fuser assembly comprising:
a body portion, said body portion fabricated from a polymeric material including and,
a lifter portion said lifter portion fabricated from PFA;
wherein one of said body portion or said lifter portion includes an edge forming a notch and the other of said body portion and said lifter portion includes an edge forming a protrusion shaped to fit into said notch to form an interference fit.

2. The stripper finger as recited in claim 1 further comprising an adhesive wherein said adhesive on one or both of said body portion edge and said lifter portion edge to hold said body portion and said lifter portion together.

3. The stripper finger as recited in claim 2 wherein said adhesive is covalently bound to one or both of said body portion and said lifter portion.

4. The stripper finger as recited in claim 1 wherein said lifter portion ranges in thickness from about 1.5 mm to about 4.5 mm.

5. The stripper finger as recited in claim 1 wherein the fabrication material for the lifter portion further comprises glass.

6. The stripper finger as recited in claim 5 wherein the glass is in the form of chopped glass.

7. The stripper finger as recited in claim 5 wherein the glass is in the form of glass beads.

8. The stripper finger as recited in claim 1 wherein the body portion is fabricated from polyphenyl sulfide polymer.

9. The stripper finger as recited in claim 1 wherein the body portion is fabricated from polyimide polymer.

10. The stripper finger as recited in claim 1 wherein the body portion is fabricated from PEEK.

11. An integral stripper finger for a fuser assembly shaped to include a body portion and a lifter portion wherein said stripper finger is fabricated from PFA.

12. The stripper finger as recited in claim 11 wherein said PFA further comprises glass.

13. The stripper finger as recited in claim 12 wherein said glass is in the form of chopped glass.

14. The stripper finger as recited in claim 12 wherein said glass is in the form of glass beads.

15. The stripper finger as recited in claim 11 wherein said stripper finger ranges in size from about 1.5 mm to about 4.5 mm.

16. The stripper finger as recited in claim 11 wherein said fabrication material further comprises PEEK.

17. An integral stripper finger for a fuser assembly shaped to include a body portion and a lifter portion wherein said stripper finger is fabricated from PEEK.

18. The stripper finger as recited in claim 17 wherein said PEEK further comprises glass.

19. The stripper finger as recited in claim 18 wherein said glass is in the form of chopped glass.

20. The stripper finger as recited in claim 18 wherein said glass is in the form of glass beads.

21. The stripper finger as recited in claim 17 wherein said stripper finger ranges in size from about 1.5 mm to about 4.5 mm.

22. An integral stripper finger for a fuser assembly shaped to include a body portion and a lifter portion wherein said stripper finger is fabricated from PPS.

23. The stripper finger as recited in claim 22 wherein said PPS further comprises glass.

24. The stripper finger as recited in claim 23 wherein said glass is in the form of chopped glass.

25. The stripper finger as recited in claim 23 wherein said glass is in the form of glass beads.

26. The stripper finger as recited in claim 22 wherein said stripper finger ranges in size from about 1.5 mm to about 4.5 mm.

27. An integral stripper finger for a fuser assembly shaped to include a body portion and a lifter portion wherein said stripper finger is fabricated from polyimide.

28. The stripper finger as recited in claim 27 wherein said polyimide further comprises glass.

29. The stripper finger as recited in claim 28 wherein said glass is in the form of chopped glass.

30. The stripper finger as recited in claim 28 wherein said glass is in the form of glass beads.

31. The stripper finger as recited in claim 27 wherein said stripper finger ranges in size from about 1.5 mm to about 4.5 mm.
